(19) United States
(12) Patent Application Publication
(10) Pub. No.: US 2025/0323542 A1
(43) Pub. Date: Oct. 16, 2025

(54) ROTOR FOR ROTARY ELECTRIC MACHINE

(71) Applicant: HONDA MOTOR CO., LTD., Tokyo (JP)

(72) Inventors: Motonori SAKAI, Tokyo (JP); Tomoya ANDO, Tokyo (JP)

(73) Assignee: HONDA MOTOR CO., LTD., Tokyo (JP)

(21) Appl. No.: 19/080,982

(22) Filed: Mar. 17, 2025

(30) Foreign Application Priority Data
Apr. 12, 2024 (JP) 2024-064573

(51) Int. Cl. H02K 1/276

(52) U.S. Cl. CPC H02K 1/2766

(57) ABSTRACT

A rotor for a rotary electric machine includes: a rotor core having a substantially annular shape centered on a rotation axis; and plural magnetic pole portions provided along a circumferential direction of the rotor core, each of the magnetic pole portions includes a magnet accommodating hole provided in the rotor core and extending in an axial direction, and at least one magnet accommodated in the magnet accommodating hole, the at least one magnet has a coercive force distribution in a predetermined direction, and the at least one magnet is accommodated in the magnet accommodating hole such that a direction of the coercive force distribution is the axial direction and a coercive force of an outer end, in the axial direction, of the at least one magnet is larger than a coercive force of an inner portion of the at least one magnet.

### CROSS-REFERENCE TO RELATED APPLICATION

This application is based on and claims priority under 35 USC 119 from Japanese Patent Application No. 2024-064573 filed on Apr. 12, 2024.

### TECHNICAL FIELD

The present invention relates to a rotor for a rotary electric machine, the rotor being provided with a magnet having a coercive force distribution.

### BACKGROUND ART

In recent years, efforts to realize a low-carbon society or a decarbonized society become active, and research and development about an electrification technique are conducted to reduce CO₂ emission and improve energy efficiency in vehicles. As an electrification technology, for example, there is a rotary electric machine such as an electric motor or an electric generator, and the rotary electric machine is mounted on an electric vehicle such as a battery electric automobile, a hybrid vehicle, or a fuel cell vehicle.

For example, Patent Literature 1 discloses a motor including a rotor and a permanent magnet. In the motor of Patent Literature 1, the permanent magnet is a magnet having a coercive force distribution in a single individual, and a coercive force of a high-temperature-side permanent magnet portion located at a high temperature portion where a temperature is high inside the motor is set to be higher than a coercive force of a low-temperature-side permanent magnet portion located at a low temperature portion where the temperature is lower than that of the high-temperature-side permanent magnet portion inside the motor. Accordingly, a motor having high motor characteristics and low cost is realized.

Patent Literature 1: JP6841130

### SUMMARY OF INVENTION

In the motor including the permanent magnet having a coercive force distribution in a single individual as described in Patent Literature 1, rapid demagnetization may occur in a portion of the permanent magnet having a low coercive force as a magnet temperature increases, and there is room for improvement.

The present invention provides a rotor for a rotary electric machine capable of preventing rapid demagnetization from occurring due to an increase in magnet temperature, the rotor being provided with a magnet having a coercive force distribution.

The present invention provides, as an aspect of the invention, a rotor for a rotary electric machine, the rotor including:
a rotor core having a substantially annular shape centered on a rotation axis, and
a plurality of magnetic pole portions provided along a circumferential direction of the rotor core, in which
each of the magnetic pole portions includes a magnet accommodating hole formed in the rotor core and extending in an axial direction, and at least one magnet accommodated in the magnet accommodating hole,
the magnet has a coercive force distribution in a predetermined direction, and
the magnet is accommodated in the magnet accommodating hole such that a direction of the coercive force distribution is the axial direction and a coercive force of an outer end, in the axial direction, of the magnet is larger than a coercive force of an inner portion of the magnet.

According to the aspect of the present invention, it is possible to prevent rapid demagnetization from occurring due to an increase in magnet temperature.

### BRIEF DESCRIPTION OF DRAWINGS

FIG. 1 is a perspective view of a rotor 10 for a rotary electric machine according to an embodiment of the present invention.

FIG. 2 is a view of a permanent magnet 41 accommodated in a magnet accommodating hole 31 as viewed from an axial direction of the rotor 10.

FIG. 3 is a perspective view of the permanent magnet 41 accommodated in the magnet accommodating hole 31 such that a direction of a coercive force distribution is the axial direction.

FIG. 4 is a perspective view of a permanent magnet 41A accommodated in the magnet accommodating hole 31 such that a direction of a coercive force distribution is a radial direction.

FIG. 5 illustrates an example of a graph comparing heat resistance of a plurality of types of permanent magnets.

FIG. 6 is a side view of a magnet group 40 according to a first modification in which permanent magnets 41L having a large size are disposed on both outer sides in the axial direction and a permanent magnet 41S having a small size is disposed on an inner side.

FIG. 7 illustrates a magnetic pole portion 30 according to a second modification in which a coercive force of the permanent magnet 41 is varied for each magnet accommodating hole 31.

### DESCRIPTION OF EMBODIMENTS

Hereinafter, an embodiment of a rotor for a rotary electric machine of the present invention will be described with reference to the accompanying drawings. In the present specification and the like, an axial direction, a radial direction, and a circumferential direction refer to directions based on a rotation axis of the rotor. An axially inner side refers to a side towards a center of the rotor in the axial direction, and an axially outer side refers to a side away from the center of the rotor in the axial direction. Further, a circumferentially inner side refers to a side toward a center of a magnetic pole portion in the circumferential direction, and a circumferentially outer side refers to a side away from the center of the magnetic pole portion in the circumferential direction.

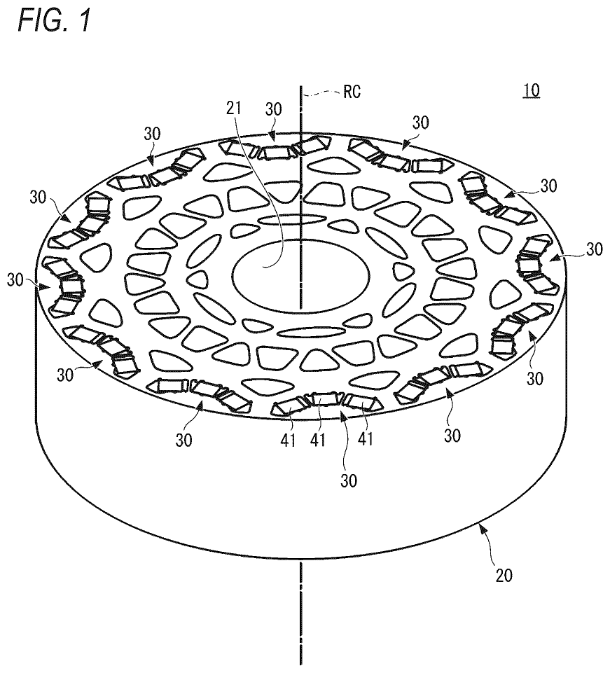

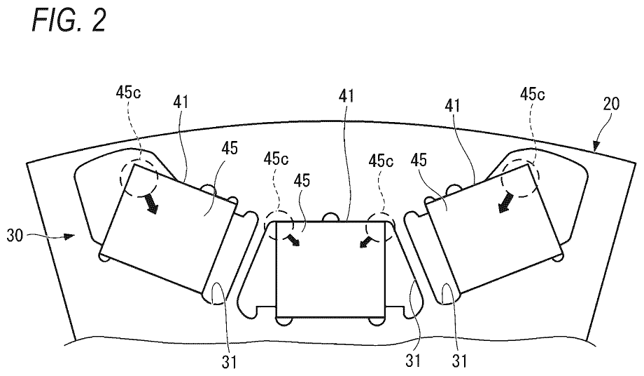

As illustrated in FIGS. 1 and 2, a rotor 10 for a rotary electric machine includes a rotor core 20 having a substantially annular shape centered on a rotation axis RC, and a plurality of magnetic pole portions 30 provided along a circumferential direction of the rotor core 20. Although not illustrated, the rotary electric machine includes the rotor 10 and a stator to which a coil is attached, and a magnetic field of the stator generated by passing a current through the coil and a magnetic field of the rotor 10 generated by a permanent magnet 41 (to be described later) attached to the rotor 10 interact with each other to rotationally drive the rotor 10.

The rotor core 20 is formed by stacking, in the axial direction, a plurality of electromagnetic steel sheets each having a substantially annular shape. A through hole 21 penetrating in the axial direction is formed at a center of the rotor core 20, and a rotor shaft (not illustrated) is press-fitted and secured into the through hole 21.

The plurality of (twelve in this embodiment) magnetic pole portions 30 are provided at equal intervals along the circumferential direction at positions on a radially outer side of the rotor core 20. Each magnetic pole portion 30 includes a magnet accommodating hole 31 formed in the rotor core 20 and extending in the axial direction, and the permanent magnet 41 accommodated in the magnet accommodating hole 31. The reference numeral 45 in FIG. 2 denotes an outer end in the axial direction of the permanent magnet 41.

Each magnetic pole portion 30 is provided with three magnet accommodating holes 31. The three magnet accommodating holes 31 are arranged in a substantially U shape that opens toward an outside of the rotor core 20. At least one permanent magnet 41 is accommodated in each magnet accommodating hole 31.

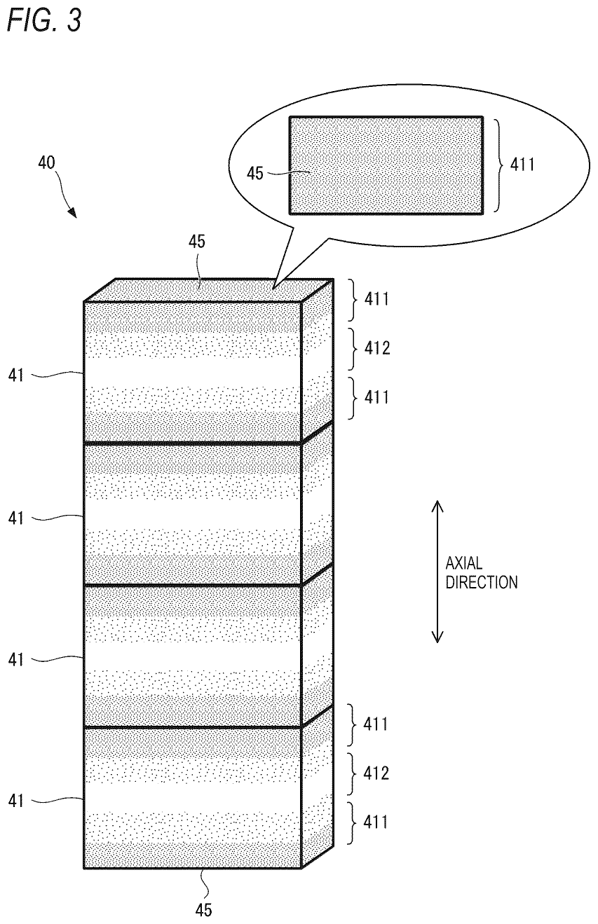

FIG. 3 illustrates an example of the permanent magnet 41 accommodated in one magnet accommodating hole 31. The shading of the color (the density of dots) in the permanent magnet 41 in FIG. 3 is conceptually made to describe a coercive force distribution to be described later.

A plurality of (four in this embodiment) permanent magnets 41 are stacked in the axial direction and accommodated in the magnet accommodating hole 31. Each permanent magnet 41 has a rectangular parallelepiped shape. In the present specification, the plurality of permanent magnets 41 stacked and accommodated in one magnet accommodating hole 31 may be collectively referred to as a magnet group 40. Further, the magnet group 40 may be constituted with one elongated permanent magnet 41 inserted through each magnet accommodating hole 31.

The permanent magnet 41 is a magnet having a portion with high coercive force (high coercive force portion 411) and a portion with low coercive force (low coercive force portion 412) within a single individual, that is, having a coercive force distribution. Here, the term “high coercive force” means that the high coercive force portion 411 has a relatively higher coercive force than the low coercive force portion 412, and the term “low coercive force” means that the low coercive force portion 412 has a relatively lower coercive force than the high coercive force portion 411. It should be noted that there is no clear boundary between the high coercive force portion 411 and the low coercive force portion 412.

The coercive force is resistance that allows a magnet to maintain an initial magnetic force by withstanding an environmental load such as a thermal history or a reverse magnetic field that attempts to lose the magnetic force. The high coercive force portion 411 is, for example, a portion in which the degree of demagnetization (that is, weakening of magnetic force) is small when placed in a high temperature state, and can also be said to be a portion having high heat resistance. The low coercive force portion 412 is, for example, a portion having a large degree of demagnetization when placed in a high temperature state, and can also be said to be a portion having low heat resistance.

The coercive force of the permanent magnet 41 is formed to have a gradient in one direction. Specifically, in the permanent magnet 41, the high coercive force portions 411 are formed on both outer sides in a predetermined direction, and the low coercive force portion 412 is formed between the high coercive force portions 411, that is, on an inner side in the predetermined direction. The permanent magnet 41 has a uniform coercive force in a direction orthogonal to the predetermined direction. In the present specification, the term “uniform coercive force” means that the coercive force is within a predetermined allowable error range.

The permanent magnet 41 is accommodated in the magnet accommodating hole 31 such that a direction of a coercive force distribution is the axial direction of the rotor 10 and a coercive force of an outer end 45 in the axial direction is larger than a coercive force of an inner portion. Specifically, each permanent magnet 41 is accommodated in the magnet accommodating hole 31 such that the high coercive force portion 411 is provided on the axially outer side and the low coercive force portion 412 is provided on the axially inner side. The high coercive force portion 411 is disposed at the outer ends 45 in the axial direction of the plurality of permanent magnets 41.

The outer end 45 in the axial direction of the permanent magnet 41 is a portion where a magnetic flux easily flows and a magnet temperature easily increases. Details thereof will be described later. During driving of the rotary electric machine, demagnetization progresses from a corner 45c to a central portion of the outer end 45 of the permanent magnet 41 illustrated in FIG. 2 (see a black arrow), but the outer end 45 is uniformly the high coercive force portion 411, and thus rapid demagnetization is prevented from occurring due to an increase in magnet temperature.

Next, the heat resistance of the permanent magnet 41 will be described by comparing the permanent magnet 41A accommodated in the magnet accommodating hole 31 such that a direction of the coercive force distribution is the radial direction of the rotor 10 with a permanent magnet having a uniform coercive force in a single individual (hereinafter, also referred to as a homogeneous magnet).

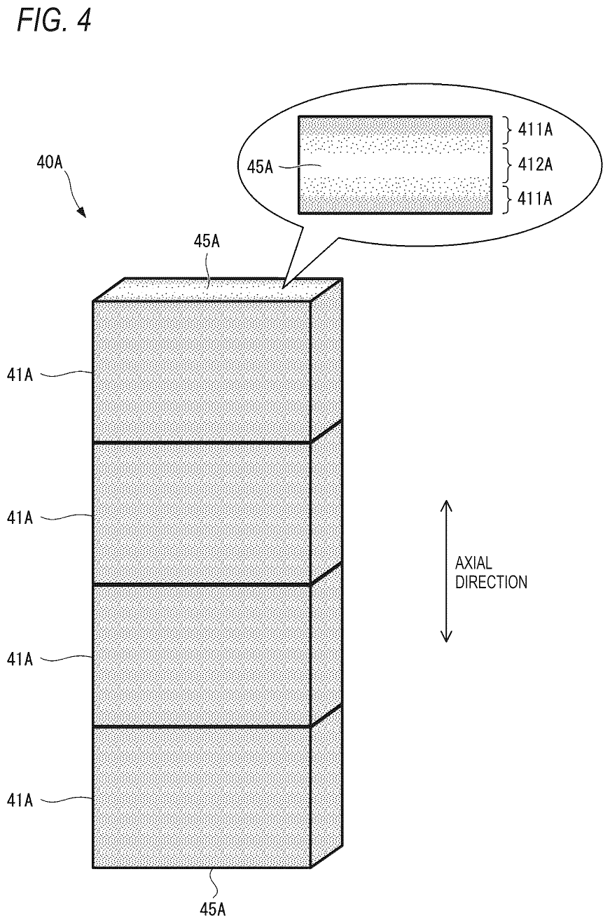

The permanent magnet 41A (magnet group 40A) illustrated in FIG. 4 is a magnet having a coercive force distribution in a single individual as in the permanent magnet 41 of the present embodiment, and is accommodated in the magnet accommodating hole 31 such that a direction of the coercive force distribution is a direction orthogonal to the axial direction of the rotor 10, for example, the radial direction. At an outer end 45A of the permanent magnet 41A in the axial direction, the coercive force distribution appears, that is, a high coercive force portion 411A which is a portion having a high coercive force and a low coercive force portion 412A which is a portion having a low coercive force are formed.

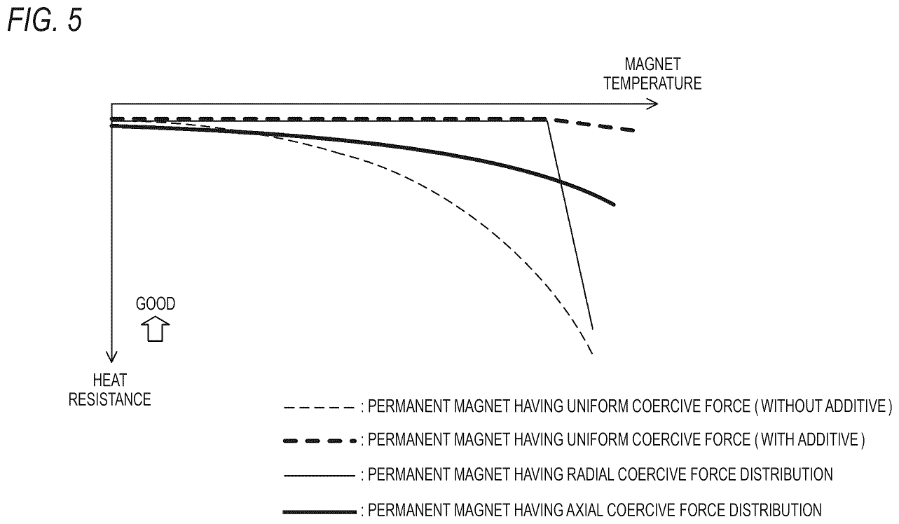

FIG. 5 is an example of a graph illustrating a comparison of heat resistance of a plurality of types of permanent magnets, in which a horizontal axis represents a magnet temperature and a vertical axis represents the heat resistance of the magnet. The heat resistance on the vertical axis means that the heat resistance is greater toward the upper side. A thin dashed line represents a graph of a homogeneous magnet to which an additive such as heavy rare earths is not added. A thick dashed line represents a graph of a homogeneous magnet in which an additive such as heavy rare earths is added to the entire magnet. A thin solid line represents a graph of the permanent magnet 41A in which a direction of the coercive force distribution is the radial direction. A thick solid line represents a graph of the permanent magnet 41 of the present embodiment in which a direction of the coercive force distribution is the axial direction.

When the permanent magnet is affected by the heat generated by the rotary electric machine during driving of the rotary electric machine and the magnet temperature increases, the demagnetization of the permanent magnet basically progresses and the heat resistance decreases. That is, when the magnet temperature increases, a voltage of the rotary electric machine decreases, and an output of the rotary electric machine decreases.

As illustrated in FIG. 5, in the homogeneous magnet without an additive, the demagnetization progresses relatively easily as the magnet temperature increases, and the heat resistance gradually decreases. In particular, in a high temperature range, the heat resistance significantly decreases.

In the homogeneous magnet with an additive, the demagnetization hardly proceeds even when the magnet temperature increases, and the heat resistance is maintained up to the high temperature range. However, since the additive is added to the entire magnet, manufacturing cost of the rotor 10 provided with the homogeneous magnet with the additive increases.

In the permanent magnet 41A having a coercive force distribution in the radial direction, the demagnetization hardly proceeds even when the magnet temperature increases, and the heat resistance is maintained up to a relatively high temperature range. The permanent magnet 41A has high heat resistance as compared with the case of using the homogeneous magnet without an additive. Further, the manufacturing cost of the rotor 10 can be reduced using the permanent magnet 41A as compared with the case of using the homogeneous magnet with an additive (that is, the magnet in which the additive is uniformly added to the entire magnet).

However, when the temperature of the permanent magnet 41A exceeds a predetermined temperature in the high temperature range, the rapid demagnetization occurs and the heat resistance rapidly decreases. Specifically, the outer end 45A of the permanent magnet 41A in the axial direction has the coercive force distribution as described above, and the outer end 45A is a portion where a magnetic flux easily flows and a magnet temperature easily increases. When the demagnetization progresses from the corner 45c (see FIG. 2) to the central portion of the permanent magnet 41A and progresses to the low coercive force portion 412A having a low coercive force during driving of the rotary electric machine, the heat resistance of the permanent magnet 41A rapidly decreases.

Returning to FIG. 5, the permanent magnet 41 of the present embodiment has lower heat resistance than the permanent magnet 41A, but has higher heat resistance than the homogeneous magnet without an additive, and the heat resistance is maintained in the relatively high temperature range. The manufacturing cost of the rotor 10 can be reduced using the permanent magnet 41 as compared with the case of using the homogeneous magnet with an additive (that is, the magnet in which the additive is uniformly added to the entire magnet). Further, the permanent magnet 41 does not cause rapid demagnetization, unlike the permanent magnet 41A, in the high temperature range. This is because the outer end 45 of the permanent magnet 41 in the axial direction is uniformly the high coercive force portion 411.

In this way, since the permanent magnet 41 of the present embodiment is accommodated in the magnet accommodating hole 31 such that a direction of the coercive force distribution is the axial direction and the coercive force of the outer end 45 in the axial direction is larger than the coercive force of the inner portion, it is possible to reduce the manufacturing cost of the rotor 10 and prevent the rapid demagnetization from occurring due to an increase in the magnet temperature.

### First Modification

The permanent magnets 41 stacked and accommodated in the magnet accommodating holes 31 may have different coercive forces. Specifically, the rotor 10 may have a configuration in which the permanent magnet 41 disposed on the outer side in the axial direction has a larger coercive force than the permanent magnet 41 disposed on the inner side. A magnitude of the coercive force can be varied depending on, for example, the size of the permanent magnet 41.

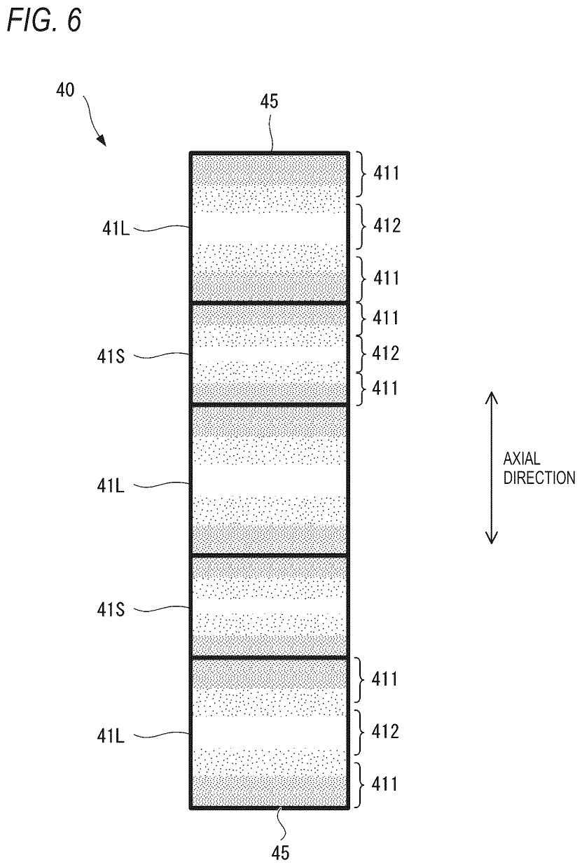

FIG. 6 is a side view of the magnet group 40 in which permanent magnets 41L having a large size are disposed on both outer sides in the axial direction and a permanent magnet 41S having a small size is disposed on an inner side. Here, the term “large size” means that the permanent magnet 41L is relatively larger than the permanent magnet 41S, and the term “small size” means that the permanent magnet 41S is relatively smaller than the permanent magnet 41L. In the example illustrated in FIG. 6, the permanent magnets 41L and the permanent magnets 41S are alternately stacked, but the arrangement method of the permanent magnets 41 is not limited thereto. For example, three (large, medium, and small) permanent magnets 41 having different sizes may be prepared, and the permanent magnets 41 may be arranged in the order of large, medium, small, medium, and large from one end side to the other end side in the axial direction.

Each of the permanent magnets 41L and 41S is accommodated in the magnet accommodating hole 31 such that the coercive force distribution is in the axial direction, and the permanent magnets 41L having a large size are disposed on both outer sides in the axial direction. The permanent magnets 41L and 41S have different lengths (thicknesses) in the axial direction and thus have different sizes. The heat resistance of the permanent magnet 41 increases as the size increases. Thus, by disposing the permanent magnets 41L on both outer sides in the axial direction, the coercive force of the outer end 45 in the axial direction can be increased.

The permanent magnets 41L and 41S may be configured to have different sizes by having different lengths in the circumferential direction.

### Second Modification

In each magnetic pole portion 30, the coercive force of the permanent magnet 41 may be varied for each magnet accommodating hole 31. Specifically, the permanent magnet 41 accommodated in the magnet accommodating hole 31 on the outer side in the circumferential direction of each magnetic pole portion 30 may have a larger coercive force than the permanent magnet 41 accommodated in the magnet accommodating hole 31 on the inner side.

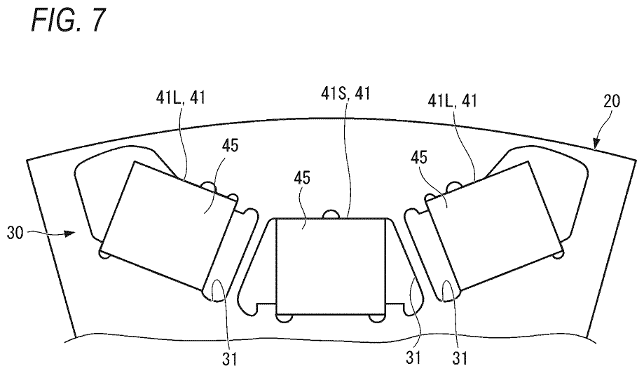

FIG. 7 illustrates the magnetic pole portion 30 in which the permanent magnets 41L having a large coercive force are disposed in the magnet accommodating holes 31 on both outer sides in the circumferential direction among the three magnet accommodating holes 31, and the permanent magnet 41S having a small coercive force is disposed in the magnet accommodating holes 31 on the inner side among the three magnet accommodating holes 31. Here, the size of the permanent magnet 41L is increased to increase the coercive force, and the size of the permanent magnet 41S is decreased to decrease the coercive force. In each magnet accommodating hole 31, each of the permanent magnets 41L and 41S is accommodated in the magnet accommodating hole 31 such that the coercive force distribution is in the axial direction.

In each magnetic pole portion 30, the magnetic flux easily flows through the permanent magnet on the circumferentially outer side. However, in Modification 2, since the permanent magnet 41L is disposed on the circumferentially outer side where the magnetic flux easily flows to increase the coercive force, the heat resistance of the magnetic pole portion 30 in the circumferential direction can be improved.

The configurations of Modification 1 and Modification 2 described above can be appropriately combined.

Although an embodiment and each modification of the present disclosure have been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, respective constituent elements in the above embodiment may be freely combined without departing from the gist of the invention.

In the present specification, at least the following matters are described. In the parentheses, the corresponding constituent elements and the like in the above embodiment are shown as an example, but the present invention is not limited thereto.
(1) A rotor (rotor 10) for a rotary electric machine, the rotor including:
a rotor core (rotor core 20) having a substantially annular shape centered on a rotation axis (rotation axis RC), and
a plurality of magnetic pole portions (magnetic pole portions 30) provided along a circumferential direction of the rotor core, in which
each of the magnetic pole portions includes a magnet accommodating hole (magnet accommodating hole 31) formed in the rotor core and extending in an axial direction, and at least one magnet (permanent magnet 41) accommodated in the magnet accommodating hole,
the magnet has a coercive force distribution in a predetermined direction, and
the magnet is accommodated in the magnet accommodating hole such that a direction of the coercive force distribution is the axial direction and a coercive force of an outer end (outer end 45) in the axial direction is larger than a coercive force of an inner portion.

According to (1), since the magnet having the coercive force distribution is provided in the magnetic pole portion of the rotor core, the heat resistance can be maintained up to the high temperature range, and the manufacturing cost of the rotor can be reduced as compared with a magnet having a uniform coercive force and to which heavy rare earths or the like are added. Further, since the magnet is accommodated in the magnet accommodating hole such that a direction of the coercive force distribution is the axial direction and the coercive force of the outer end, in the axial direction, of the magnet is larger than the coercive force of the inner portion of the magnet, the coercive force is large and the coercive force distribution is uniform at the outer end in the axial direction in which the magnetic flux easily flows. Thus, it is possible to prevent rapid demagnetization from occurring due to an increase in magnet temperature.
(2) The rotor for a rotary electric machine according to (1), in which
a plurality of magnets (permanent magnets 41L and 41S) are accommodated in each of the magnet accommodating holes, and
a magnet (permanent magnet 41L), among the plurality of magnets, disposed on an outer side in the axial direction has a larger coercive force than a magnet (permanent magnet 41S), among the plurality of magnets, disposed on an inner side in the axial direction.

According to (2), since the coercive force of the outer end in the axial direction in which the magnetic flux easily flows is large, it is possible to more reliably prevent occurrence of rapid demagnetization.
(3) The rotor for a rotary electric machine according to (2), in which
the magnet disposed on the outer side in the axial direction is larger in size than the magnet disposed on the inner side.

According to (3), the coercive force of the outer end in the axial direction can be increased by increasing the size of the magnet disposed on the outer side in the axial direction.
(4) The rotor for the rotary electric machine according to (3), in which
the magnet disposed on the outer side in the axial direction is longer in the axial direction than the magnet disposed on the inner side.

According to (4), the coercive force of the outer end in the axial direction can be increased by lengthening, in the axial direction, the magnet disposed on the outer side in the axial direction.
(5) The rotor for a rotary electric machine according to any one of (1) to (4), in which
each of the magnetic pole portions has a plurality of the magnet accommodating holes along the circumferential direction, and
a magnet (permanent magnet 41L) accommodated in the magnet accommodating hole on an outer side in the circumferential direction of each of the magnetic pole portions has a larger coercive force than a magnet (permanent magnet 41S) accommodated in the magnet accommodating hole on an inner side.

According to (5), since the coercive force of the magnet on the outer side in the circumferential direction in which the magnetic flux easily flows in each magnetic pole portion is large, it is possible to more reliably prevent the occurrence of rapid demagnetization.

### REFERENCE SIGNS LIST

10 rotor
20 rotor core
30 magnetic pole portion
31 magnet accommodating hole
41 permanent magnet (magnet)
45 outer end
RC rotation axis

What is claimed is:

1. A rotor for a rotary electric machine, the rotor comprising:
a rotor core having a substantially annular shape centered on a rotation axis; and
a plurality of magnetic pole portions provided along a circumferential direction of the rotor core, wherein
each of the magnetic pole portions includes a magnet accommodating hole provided in the rotor core and extending in an axial direction, and at least one magnet accommodated in the magnet accommodating hole,
the at least one magnet has a coercive force distribution in a predetermined direction, and
the at least one magnet is accommodated in the magnet accommodating hole such that a direction of the coercive force distribution is the axial direction and a coercive force of an outer end, in the axial direction, of the at least one magnet is larger than a coercive force of an inner portion of the at least one magnet.

2. The rotor for a rotary electric machine according to claim 1, wherein
the at least one magnet accommodated in the magnet accommodating hole is a plurality of magnets, and
a magnet, among the plurality of magnets, disposed on an outer side in the axial direction has a larger coercive force than a coercive force of a magnet, among the plurality of magnets, disposed on an inner side in the axial direction.

3. The rotor for a rotary electric machine according to claim 2, wherein
the magnet disposed on the outer side in the axial direction is larger in size than the magnet disposed on the inner side in the axial direction.

4. The rotor for the rotary electric machine according to claim 3, wherein
the magnet disposed on the outer side in the axial direction is longer in the axial direction than the magnet disposed on the inner side in the axial direction.

5. The rotor for a rotary electric machine according to claim 1, wherein
each of the magnetic pole portions has a plurality of the magnet accommodating holes along the circumferential direction, and
the magnet accommodated in the magnet accommodating hole, among the plurality of the magnet accommodating holes, on an outer side in the circumferential direction of each of the magnetic pole portions has a larger coercive force than a larger coercive force of the magnet accommodated in the magnet accommodating hole, among the plurality of the magnet accommodating holes, on an inner side in the circumferential direction.

6. The rotor for a rotary electric machine according to claim 2, wherein
each of the magnetic pole portions has a plurality of the magnet accommodating holes along the circumferential direction, and
the magnet accommodated in the magnet accommodating hole, among the plurality of the magnet accommodating holes, on an outer side in the circumferential direction of each of the magnetic pole portions has a larger coercive force than a larger coercive force of the magnet accommodated in the magnet accommodating hole, among the plurality of the magnet accommodating holes, on an inner side in the circumferential direction.

7. The rotor for a rotary electric machine according to claim 3, wherein
each of the magnetic pole portions has a plurality of the magnet accommodating holes along the circumferential direction, and
the magnet accommodated in the magnet accommodating hole, among the plurality of the magnet accommodating holes, on an outer side in the circumferential direction of each of the magnetic pole portions has a larger coercive force than a larger coercive force of the magnet accommodated in the magnet accommodating hole, among the plurality of the magnet accommodating holes, on an inner side in the circumferential direction.

8. The rotor for a rotary electric machine according to claim 4, wherein
each of the magnetic pole portions has a plurality of the magnet accommodating holes along the circumferential direction, and
the magnet accommodated in the magnet accommodating hole, among the plurality of the magnet accommodating holes, on an outer side in the circumferential direction of each of the magnetic pole portions has a larger coercive force than a larger coercive force of the magnet accommodated in the magnet accommodating hole, among the plurality of the magnet accommodating holes, on an inner side in the circumferential direction.
